(19) United States
(12) Patent Application Publication
(10) Pub. No.: US 2025/0229552 A1
(43) Pub. Date: Jul. 17, 2025

(54) PRINTING CASSETTE INCLUDING PRINTING TAPE ROLL AND FIRST CASE HAVING FIRST OUTER SURFACE, SECOND OUTER SURFACE, THIRD OUTER SURFACE AND FOURTH OUTER SURFACE

(71) Applicant: BROTHER KOGYO KABUSHIKI KAISHA, Nagoya (JP)

(72) Inventor: Shinji UKAI, Kiyosu (JP)

(21) Appl. No.: 19/170,537

(22) Filed: Apr. 4, 2025

Related U.S. Application Data
(63) Continuation of application No. PCT/JP2023/035645, filed on Sep. 29, 2023.

(30) Foreign Application Priority Data
Oct. 11, 2022 (JP) 2022-163002

(51) Int. Cl. B41J 15/04; B41J 15/02

(52) U.S. Cl. CPC B41J 15/044; B41J 15/02

(57) ABSTRACT

A printing cassette includes: a printing tape roll; and a first case arranged at a different position from the printing tape roll in a first direction. The first case has a discharge opening, a conveying passage, a first outer surface, a second outer surface, a third outer surface and a fourth outer surface. The printing tape roll has an overlapping portion overlapping the first case in the first direction. At least one of the first outer surface, the second outer surface, the third outer surface, or the fourth outer surface is spaced apart from the central axis of the printing tape roll by a distance that is shorter than an outer radius of the printing tape roll.

### REFERENCE TO RELATED APPLICATIONS

This is a by-pass continuation application of International Application No. PCT/JP2023/035645 filed on Sep. 29, 2023 which claims priority from Japanese Patent Application No. 2022-163002 filed on Oct. 11, 2022. The entire contents of the International Application and the priority application are incorporated herein by reference.

### BACKGROUND ART

In a printing device that prints on printing tape, cassettes accommodating printing tape are attached to and detached from the printing device body to supply and interchange the printing tape. In such cassettes used in the printing device, the capacity of printing tape can be increased by increasing the diameter of the printing tape roll.

### SUMMARY

Increasing the diameter of the printing tape roll as described above requires the size of the cassette to be increased in the radial directions of the printing tape roll. Therefore, the capacity of the printing tape roll is limited by the shape of the cassette accommodation part of the printing device body.

In view of the foregoing, it is an object of the present disclosure to provide a printing cassette that can increase the capacity of printing tape.

In order to attain the above and other objects, the present disclosure provides a printing cassette including a printing tape roll and a first case. The printing tape roll includes a printing tape. The first case is arranged at a different position from the printing tape roll in a first direction parallel to a central axis of the printing tape roll. The first case has a discharge opening, a conveying passage, a first outer surface, a second outer surface, a third outer surface, and a fourth outer surface. The discharge opening allows the printing tape to be discharged outside. The printing tape drawn off the printing tape roll is conveyed toward the discharging opening through the conveying passage. The first outer surface and the second outer surface constitute outermost surfaces of the first case in a second direction parallel to a discharging direction in which the printing tape is discharged at the discharging opening. The third outer surface and the fourth outer surface constitute outermost surfaces of the first case in a third direction orthogonal to both the first direction and the second direction. The printing tape roll has an overlapping portion overlapping the first case in the first direction. At least one of the first outer surface, the second outer surface, the third outer surface, or the fourth outer surface is spaced apart from the central axis of the printing tape roll by a distance that is shorter than an outer radius of the printing tape roll.

In the above structure, since the printing tape roll and the first case are arranged at different positions in the axial direction of the printing tape roll, the diameter of the printing tape roll can be increased while preserving the size of the first case, which is to be inserted in the printing device body. As a result, the capacity of the printing tape can be increased while reducing restrictions caused by the shape of the cassette accommodation part formed in the printing device body.

### BRIEF DESCRIPTION OF DRAWINGS

FIG. 1 is a schematic perspective view illustrating a printing device according to an embodiment.

FIG. 2A is a schematic top view illustrating a printing device body of the printing device illustrated in FIG. 1.

FIG. 2B is a schematic perspective view illustrating the printing device body illustrated in FIG. 2A.

FIG. 3A is a schematic perspective views illustrating a printing cassette of the printing device illustrated in FIG. 1.

FIG. 3B is a schematic perspective views illustrating a printing cassette of the printing device illustrated in FIG. 1.

FIG. 4 is a schematic exploded perspective view illustrating the printing cassette illustrated in FIG. 3A.

FIG. 5 is a schematic plan view illustrating the internal structure of a first frame part of the printing cassette illustrated in FIG. 3A.

FIG. 6 is a schematic perspective view illustrating the internal structure of a second frame part of the printing cassette illustrated in FIG. 3A.

FIG. 7 is a schematic plan view illustrating the printing cassette illustrated in FIG. 3A.

FIG. 8 is a schematic plan view illustrating the second frame part and a drive transmission mechanism of the printing cassette illustrated in FIG. 3A.

### DESCRIPTION

### 1. First Embodiment

### 1-1. Configuration

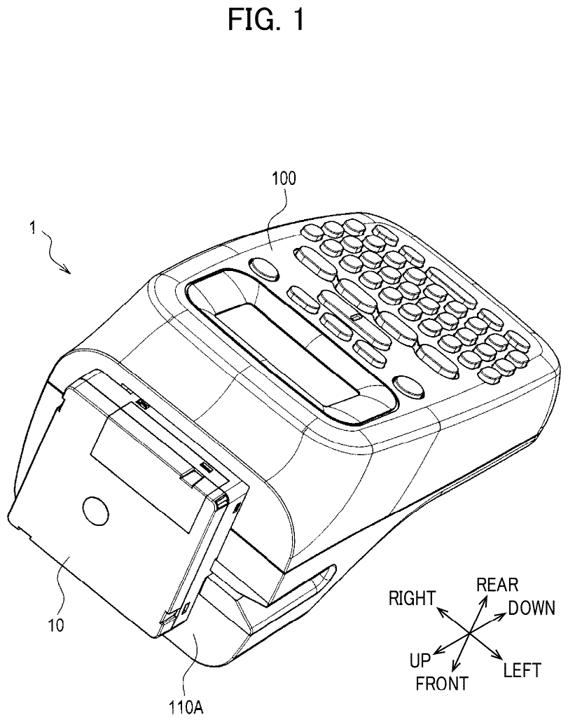

A printing device 1 shown in FIG. 1 includes a printing cassette 10, and a printing device body 100. The printing device 1 is a device configured to print on a printing tape 11A.

In the present embodiment, a direction parallel to the central axis of a printing tape roll 11 will be defined as the up-down direction (the first direction); a direction orthogonal to the up-down direction that is parallel to the direction in which the printing tape 11A is discharged through a discharge opening 32C will be defined as the left-right direction (the second direction); and a direction orthogonal to both the up-down direction and the left-right direction will be defined as the front-rear direction (the third direction).

### <Printing Device Body>

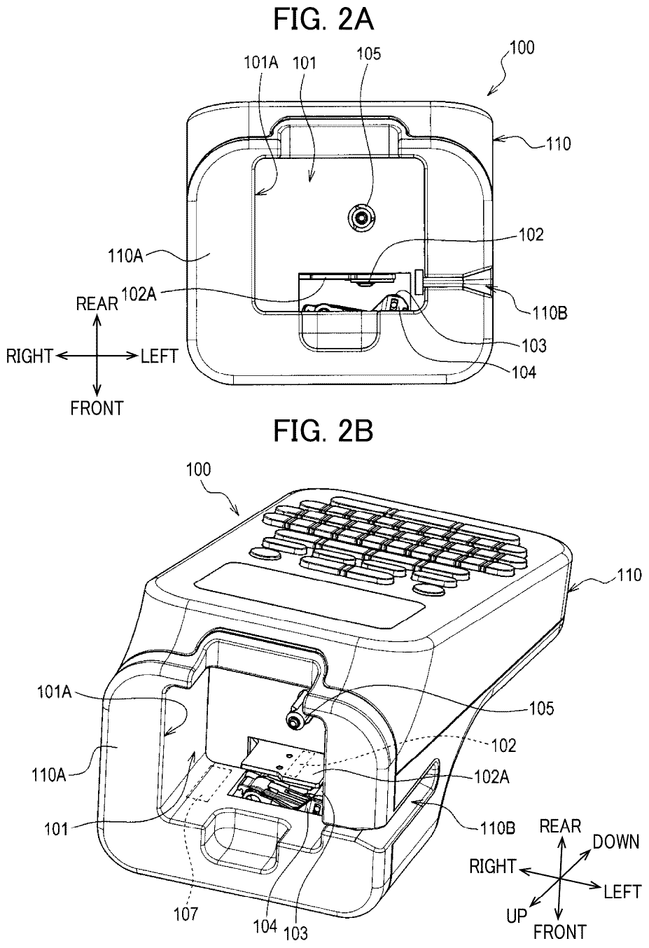

As shown in FIGS. 2A and 2B, the printing device body 100 includes a cassette accommodation part 101, a print head 102, a platen roller 103, a roller holder 104, a drive shaft 105, a detection unit 107, and a housing 110.

### (Cassette Accommodation Part)

The cassette accommodation part 101 is a recess to which the printing cassette 10 is to be attached. The cassette accommodation part 101 has a function to position the printing cassette 10.

The cassette accommodation part 101 has an opening 101A formed in the housing 110. The printing cassette 10 is to be accommodated inside the cassette accommodation part 101 by being inserted into the cassette accommodation part 101 through the opening 101A. The housing 110 includes a slit-shaped discharge portion 110B that is in communication with the cassette accommodation part 101. The printing tape 11A is discharged through the discharge portion 110B.

### (Print Head)

The print head 102 is arranged inside the cassette accommodation part 101. The print head 102 has a plurality of heating elements whose heating is individually controlled.

### (Platen Roller)

The platen roller 103 is arranged inside the cassette accommodation part 101. The platen roller 103 is positioned near the print head 102 so as to face the print head 102. The platen roller 103 can pivot in directions toward and away from the print head 102. The rotational axis of the platen roller 103 is parallel to the up-down direction.

A platen gear (not shown) configured to engage with an output gear 21 of the printing cassette 10 is coupled to the platen roller 103. The platen gear is configured to pivot together with the platen roller 103.

### (Roller Holder)

The roller holder 104 holds the platen roller 103. The roller holder 104 is mounted in the housing 110 so as to be pivotable in the front-rear direction.

### (Drive Shaft)

The drive shaft 105 is to be inserted into a take-up spool 16 and an input gear 22 of the printing cassette 10. The drive shaft 105 is configured to input a drive force into the printing cassette 10 for rotating the take-up spool 16 and input gear 22.

The drive shaft 105 is arranged inside the cassette accommodation part 101. The rotational axis of the drive shaft 105 is parallel to the up-down direction. The drive shaft 105 is rotated about its rotational axis by a drive source (not shown in the drawings) having a combination of a motor and gears, for example.

### (Detection Unit)

The detection unit 107 is configured to detect, from the printing cassette 10, cassette identification information assigned to the printing cassette 10. The detection unit 107 is configured to detect this identification information from a detection target part 32E of the printing cassette 10 using a mechanical, optical, or electromagnetic reading sensor.

### <Printing Cassette>

The printing cassette 10 accommodates the printing tape 11A. The printing cassette 10 is attachable to the printing device body 100 and is detachable from the printing device body 100. Printing cassettes 10 can be interchanged to replenish the printing tape 11A and to change the type of printing tape 11A (e.g., the size, color, and material).

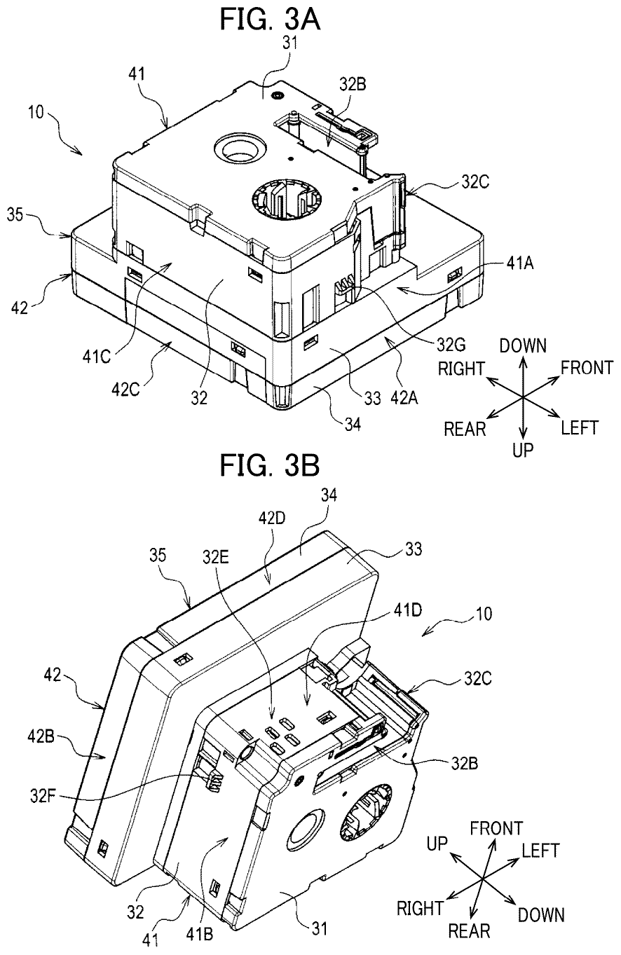

As shown in FIGS. 3A and 3B, the printing cassette 10 includes a main case 35 that accommodates at least a portion of the printing tape 11A and at least a portion of an ink ribbon 14A (i.e., the auxiliary tape).

The main case 35 includes a first case 41 and a second case 42. Each of the first case 41 and second case 42 is a rectangular parallelepiped having sides that are parallel in the up-down direction, sides that are parallel in the front-rear direction, and sides that are parallel in the left-right direction.

The first case 41 is connected to the second case 42 so as to protrude downward from the bottom surface of the second case 42. In a state where the printing cassette 10 is attached to the cassette accommodation part 101, the first case 41 is positioned inside the cassette accommodation part 101. The main case 35 is to be inserted into the cassette accommodation part 101 in an orientation where the first case 41 faces the bottom surface of the cassette accommodation part 101.

Viewed along the up-down direction, the area of the second case 42 is greater than the area of the opening 101A of the cassette accommodation part 101. Therefore, the second case 42 is not inserted into the cassette accommodation part 101 but is positioned outside the cassette accommodation part 101.

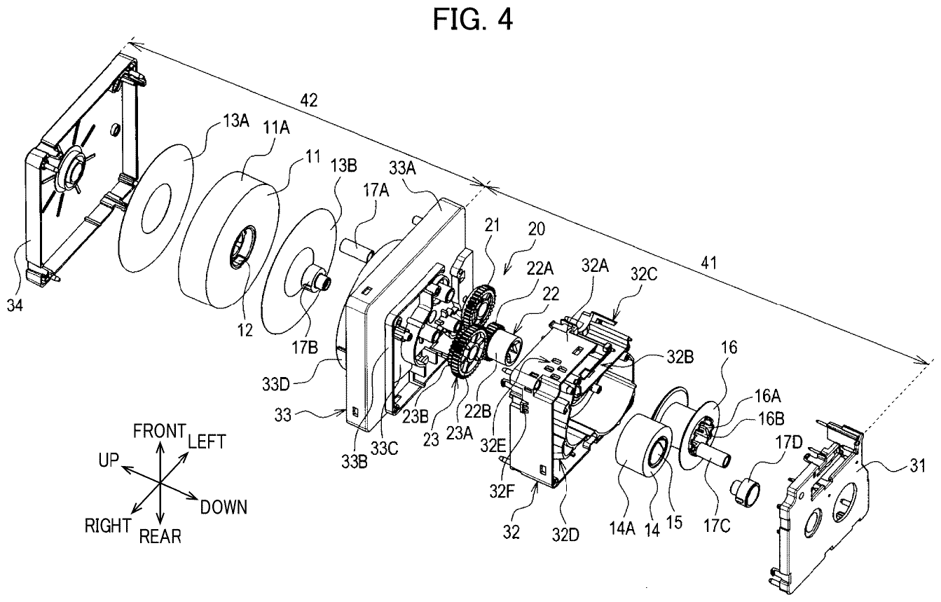

As shown in FIG. 4, the printing cassette 10 includes the printing tape roll 11, a first supply spool 12, an auxiliary tape roll 14, a second supply spool 15, the take-up spool 16, and a drive transmission mechanism 20.

### (Printing Tape Roll)

The printing tape roll 11 includes the printing tape 11A wound about the first supply spool 12. The printing tape 11A is strip-shaped, on which printing is performed. Printing is performed on the surface of the printing tape 11A using the print head 102 of the printing device body 100 and the ink ribbon 14A.

Two spacer films 13A and 13B are arranged on respective outer sides of the printing tape roll 11 in the up-down direction so as to sandwich the printing tape roll 11. The spacer film 13A is arranged between the printing tape roll 11 and a second cover part 34. The spacer film 13B is arranged between the printing tape roll 11 and a second frame part 33. The printing tape 11A drawn off the printing tape roll 11 is guided by a first roller 17A and a second roller 17C.

### (First Supply Spool)

The first supply spool 12 is rotatable about a rotational axis parallel to the up-down direction. The first supply spool 12 rotates as the platen roller 103 of the printing device body 100 conveys the printing tape 11A, thereby supplying the printing tape 11A to the print head 102.

The rotational axis of the first supply spool 12 coincides with the central axis of the printing tape roll 11. Rotational resistance is applied to the first supply spool 12 by a clutch spring held in a first clutch spring holder 17B.

### (Auxiliary Tape Roll)

The auxiliary tape roll 14 includes the ink ribbon 14A wound about the second supply spool 15. The ink ribbon 14A is strip-shaped and is used for printing on the printing tape 11A.

The ink ribbon 14A is to be overlaid on the printing tape 11A within a head opening 32B and then to be used for printing by the print head 102. The ink ribbon 14A is taken up on the take-up spool 16 after used for printing.

The auxiliary tape roll 14 is arranged at a different position from the printing tape roll 11 in the up-down direction (and specifically is lower than the printing tape roll 11). At least a portion of the auxiliary tape roll 14 is arranged at a position overlapping the printing tape roll 11 in the up-down direction.

### (Second Supply Spool)

The second supply spool 15 is rotatable about a rotational axis. The rotational axis of the second supply spool 15 is parallel to the up-down direction.

The second supply spool 15 rotates as the take-up spool 16 takes up the ink ribbon 14A, thereby supplying the ink ribbon 14A to the print head 102. Rotational resistance is applied to the second supply spool 15 by a clutch spring held in a second clutch spring holder 17D.

### (Take-Up Spool)

The take-up spool 16 is rotatable about a rotational axis. The rotational axis of the take-up spool 16 is parallel to the rotational axis of the second supply spool 15.

The take-up spool 16 is cylindrical and has a hollow area defined by an inner circumferential surface 16A. Splines 16B are provided on the inner circumferential surface 16A of the take-up spool 16. The drive shaft 105 of the printing device body 100 is to be coupled to the splines 16B. The take-up spool 16 is rotated by the drive shaft 105, thereby taking up the ink ribbon 14A.

### (Drive Transmission Mechanism)

The drive transmission mechanism 20 is configured to transmit the drive force from the drive shaft 105 to the platen roller 103 while the printing cassette 10 is attached to the printing device body 100. The drive transmission mechanism 20 includes the output gear 21, the input gear 22, and an idle gear 23.

The printing tape roll 11, drive transmission mechanism 20, and take-up spool 16 are arranged in the up-down direction in the order of the printing tape roll 11, drive transmission mechanism 20, and take-up spool 16.

### (Output Gear)

The output gear 21 is an external gear provided for externally outputting a drive force used for conveying the printing tape 11A. Specifically, the output gear 21 is configured to transmit the drive force to the platen gear of the printing device body 100.

The rotational axis of the output gear 21 is parallel to the rotational axis of the second supply spool 15. The output gear 21 is partially exposed in a space that is in communication with the head opening 32B. In a state where the printing cassette 10 is attached to the printing device body 100 (i.e., in a state where the main case 35 is accommodated in the cassette accommodation part 101), the output gear 21 engages with the platen gear within the space in communication with the head opening 32B.

### (Input Gear)

The input gear 22 is indirectly engaged with the output gear 21 via the idle gear 23. The input gear 22 is configured to transmit a drive force to the output gear 21.

The input gear 22 includes an external gear 22A, and a spool 22B. The spool 22B is fixed to one side surface of the external gear 22A. The spool 22B is a cylindrical internal gear whose inner circumferential surface has splines. The external gear 22A is rotatable together with the spool 22B by the drive force inputted into the spool 22B. The rotational axis of the input gear 22 (i.e., the rotational axes of the external gear 22A and spool 22B) is arranged coaxially with the rotational axis of the take-up spool 16.

The rotational axis of the input gear 22 overlaps the hollow area of the take-up spool 16 in the up-down direction. Accordingly, the drive shaft 105 is simultaneously inserted into the take-up spool 16 and the input gear 22 in a state where the printing cassette 10 is attached to the printing device body 100. As a result, the input gear 22, although not directly coupled with the take-up spool 16, is rotated together with the take-up spool 16 by the drive shaft 105.

### (Idle Gear)

The idle gear 23 is drivingly coupled to (i.e., engaged with) the input gear 22 and output gear 21. The idle gear 23 is configured to transmit the drive force inputted into the input gear 22 to the output gear 21.

The idle gear 23 is a stepped gear having an upstream gear 23A engaged with the input gear 22, and a downstream gear 23B engaged with the output gear 21. The upstream gear 23A and downstream gear 23B are coaxially juxtaposed. The diameter of the downstream gear 23B is smaller than the diameter of the upstream gear 23A. The downstream gear 23B is arranged closer to the printing tape roll 11 in the up-down direction than the upstream gear 23A is to the printing tape roll 11 in the up-down direction (i.e., the downstream gear 23B is arranged above the upstream gear 23A).

The idle gear 23 is configured to transmit the drive force inputted into the input gear 22 to the output gear 21 while reducing the rotational speed of the inputted drive force. That is, the drive transmission mechanism 20 includes a reduction mechanism whose reduction ratio is the transmission ratio obtained by dividing the rotational speed of the input gear 22 by the rotational speed of the output gear 21.

### (Case)

The main case 35 includes a first cover part 31, a first frame part 32, the second frame part 33, and the second cover part 34.

The first cover part 31 constitutes the lower end portion of the printing cassette 10. The first frame part 32 is arranged above the first cover part 31 and is coupled to the first cover part 31 in the up-down direction. The second frame part 33 is arranged above the first frame part 32 and is coupled to the first frame part 32 in the up-down direction. The second cover part 34 constitutes the upper end portion of the printing cassette 10. The second cover part 34 is coupled to the second frame part 33 in the up-down direction.

The first cover part 31, first frame part 32, and a portion of the second frame part 33 constitute the first case 41. The first case 41 accommodates therein the auxiliary tape roll 14, second supply spool 15, take-up spool 16, and drive transmission mechanism 20. The first case 41 is arranged at a different position from the printing tape roll 11 (and specifically is lower than the printing tape roll 11) in the up-down direction.

The auxiliary tape roll 14, second supply spool 15, and take-up spool 16 are arranged in the space enclosed by the first cover part 31 and first frame part 32. The drive transmission mechanism 20 is arranged in the space enclosed by the first frame part 32 and second frame part 33. In other words, the drive transmission mechanism 20 is arranged between the printing tape roll 11 and the auxiliary tape roll 14 in the up-down direction.

The second cover part 34 and second frame part 33 constitute the second case 42, which accommodates the printing tape roll 11. That is, the printing tape roll 11 is arranged in the space enclosed by the second cover part 34 and second frame part 33.

The first frame part 32 has a first side wall 32A, the head opening 32B, the discharge opening 32C, a conveying passage 32D, the detection target part 32E, a first pawl 32F, and a second pawl 32G (see FIG. 3A). The first side wall 32A constitutes the outer side surfaces of the main case 35 that are parallel to the up-down direction.

The head opening 32B is a part formed by cutting out a part of the first side wall 32A. The head opening 32B is the space in which the print head 102 and a holding member 102A are arranged in a state where the printing cassette 10 is attached to the printing device body 100. The holding member 102A holds the print head 102. In other words, the head opening 32B includes a printing space in which printing is performed, and a recess that is in communication with the printing space in the left-right direction.

Printing is performed on the printing tape 11A by the print head 102 in the head opening 32B. The head opening 32B opens downward at the bottom of the printing cassette 10 so that the print head 102 can be inserted into the head opening 32B from below.

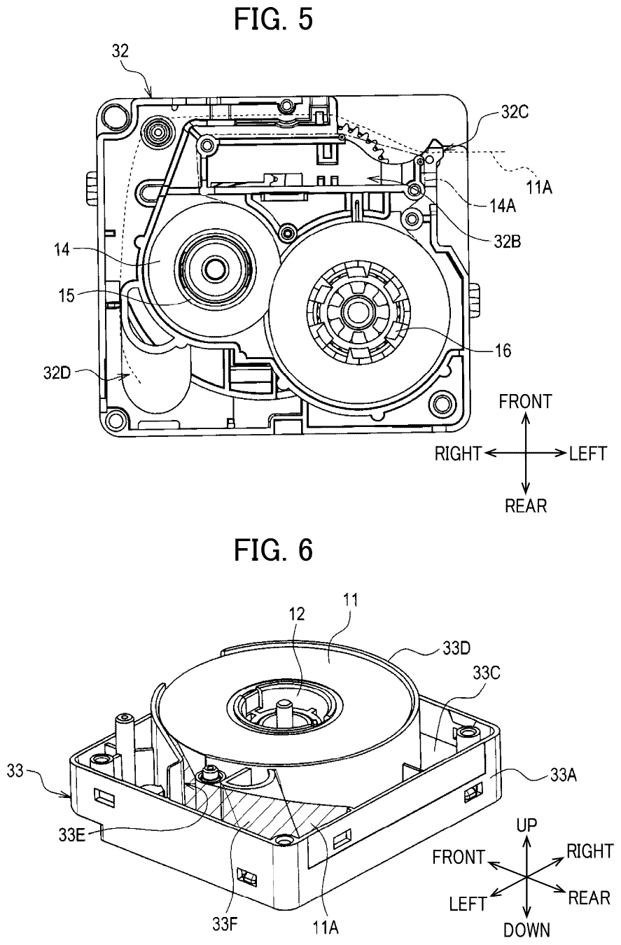

As shown in FIG. 5, the printing tape 11A and the ink ribbon 14A bridge over the left area of the head opening 32B in the left-right direction. In the head opening 32B, the printing tape 11A is exposed outside the main case 35 and is overlaid on the ink ribbon 14A. The printing tape 11A on which printing has been performed is discharged outside the printing device 1 through the discharge opening 32C. The discharge direction in which the printing tape 11A is discharged at the discharge opening 32C is the leftward direction.

The conveying passage 32D is a space through which the printing tape 11A drawn off the printing tape roll 11 is conveyed toward the discharge opening 32C. Specifically, the conveying passage 32D is for conveying the printing tape 11A from an opening that is in communication with the interior of the second case 42 to the head opening 32B.

The detection target part 32E shown in FIG. 4 enables the printing device body 100 to detect identification information for identifying the printing cassette 10. The detection target part 32E has recesses, holes, and/or protrusions formed in or at the first side wall 32A. The detection target part 32E enables the detection unit 107 of the printing device body 100 to detect identification information of the printing cassette 10 through contact or noncontact reading of a three-dimensional marker including a combination of recesses, holes, and/or protrusions.

The detection target part 32E may also include a radio-frequency identification (RFID) tags in place of or together with the three-dimensional marker. In other words, the detection target part 32E may enable the detection unit 107 to detect identification information through wireless communication.

The first pawl 32F protrudes rightward from the right side surface of the first side wall 32A. The second pawl 32G shown in FIG. 3A protrudes leftward from the left side surface of the first side wall 32A. The first pawl 32F and second pawl 32G are to engage with the printing device body 100 (and specifically the cassette accommodation part 101), into which the first case 41 is inserted.

The second frame part 33 shown in FIG. 4 includes a second side wall 33A, an auxiliary wall 33B, a partitioning wall 33C, and a roll frame part 33D. The second side wall 33A constitutes the outer side surfaces of the main case 35 that extend parallel to the up-down direction. The auxiliary wall 33B protrudes downward from the partitioning wall 33C and is coupled to the first side wall 32A of the first frame part 32.

The partitioning wall 33C has surfaces orthogonal to the up-down direction and extends in the front-rear direction and left-right direction. The partitioning wall 33C is arranged between the printing tape roll 11 and the drive transmission mechanism 20 in the up-down direction, i.e., between the first supply spool 12 and the conveying passage 32D.

The region of the partitioning wall 33C that overlaps the first frame part 32 in the up-down direction constitutes a partition wall between the first case 41 and second case 42. In other words, the partitioning wall 33C constitutes the top wall of the first case 41 and the bottom wall of the second case 42.

As shown in FIG. 6, the roll frame part 33D protrudes upward from the partitioning wall 33C. The roll frame part 33D surrounds the printing tape roll 11 from the radial outside. The printing tape 11A is drawn off the printing tape roll 11 through an opening 33E of the roll frame part 33D.

The printing tape 11A drawn off the printing tape roll 11 is guided downward by a guide 33F provided on the roll frame part 33D and is conveyed to the conveying passage 32D of the first case 41.

### <Positions and Shapes of the Cases>

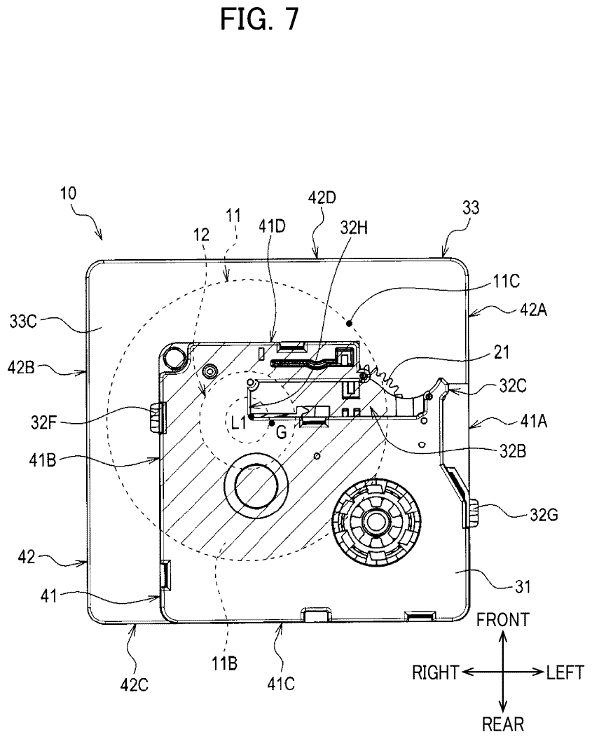

As shown in FIG. 7, the first case 41 has a first outer surface 41A, a second outer surface 41B, a third outer surface 41C and a fourth outer surface 41D. The first outer surface 41A and second outer surface 41B constitute the outermost surfaces of the first case 41 in the left-right direction. The third outer surface 41C and fourth outer surface 41D constitute the outermost surfaces of the first case 41 in the front-rear direction.

The first outer surface 41A is the left outermost surface of the first case 41. The second outer surface 41B is the right outermost surface of the first case 41. The discharge opening 32C allows the printing tape 11A to be discharged from the inside of the first outer surface 41A toward the outside of the first outer surface 41A when viewed in the up-down direction. In other words, the first outer surface 41A is positioned further leftward relative to the discharge opening 32C.

The third outer surface 41C is the rear outermost surface of the first case 41. The fourth outer surface 41D is the front outermost surface of the first case 41. The third outer surface 41C is arranged farther from the head opening 32B in the front-rear direction than the fourth outer surface 41D is from the head opening 32B in the front-rear direction.

The printing tape roll 11 has an overlapping portion 11B, which overlaps the first case 41 in the up-down direction. The printing tape roll 11 has a draw-off portion 11C at which the printing tape 11A is drawn off the printing tape roll 11. The overlapping portion 11B does not include the draw-off portion 11C. That is, the draw-off portion 11C does not overlap the first case 41 in the up-down direction.

The portion of the outer circumferential surface of the printing tape roll 11 that is included in the overlapping portion 11B has a length less than half the total circumferential length of the printing tape roll 11. In other words, the portion of the outer circumferential surface of the printing tape roll 11 that does not overlap the first case 41 in the up-down direction has a length larger than half the total circumferential length of the printing tape roll 11.

Each of the second outer surface 41B and fourth outer surface 41D is spaced apart from a central axis L1 of the printing tape roll 11 by a distance that is shorter than the outer radius of the printing tape roll 11. Hence, the printing tape roll 11 protrudes further rightward relative to the second outer surface 41B and protrudes further frontward relative to the fourth outer surface 41D when viewed in the up-down direction.

On the other hand, each of the first outer surface 41A and third outer surface 41C is spaced apart from the central axis L1 of the printing tape roll 11 by a distance that is longer than the outer radius of the printing tape roll 11. Hence, the first outer surface 41A is positioned further leftward relative to the outer circumferential surface of the printing tape roll 11, and the third outer surface 41C is positioned further rearward relative to the outer circumferential surface of the printing tape roll 11.

As illustrated in FIG. 1, in a state where the first case 41 is inserted in the cassette accommodation part 101, the printing tape roll 11, together with the second case 42, overlaps a surface 110A around the opening 101A of the cassette accommodation part 101 in the up-down direction. That is, the printing tape roll 11 does not enter the inside of the cassette accommodation part 101.

As shown in FIG. 7, the first pawl 32F is provided on the second outer surface 41B (i.e., the outer surface that is spaced apart from the central axis L1 of the printing tape roll 11 by a distance that is shorter than the outer radius of the printing tape roll 11). The first pawl 32F overlaps the printing tape roll 11 in the up-down direction. Note that the second pawl 32G is provided on the first outer surface 41A and does not overlap the printing tape roll 11 in the up-down direction.

As shown in FIG. 3B, the detection target part 32E is provided in or at the fourth outer surface 41D (i.e., the outer surface that is spaced apart from the central axis L1 of the printing tape roll 11 by a distance that is shorter than the outer radius of the printing tape roll 11). The fourth outer surface 41D faces the roller holder 104 of the printing device body 100 in a state where the first case 41 is inserted in the printing device body 100.

As shown in FIG. 7, the second case 42 has a fifth outer surface 42A, a sixth outer surface 42B, a seventh outer surface 42C and an eighth outer surface 42D. The printing tape roll 11 is interposed between the fifth outer surface 42A and the sixth outer surface 42B in the left-right direction. The printing tape roll 11 is interposed between the seventh outer surface 42C and the eighth outer surface 42D in the front-rear direction.

The fifth outer surface 42A is the left outermost surface of the second case 42. The sixth outer surface 42B is the right outermost surface of the second case 42. The fifth outer surface 42A is arranged closer to the first outer surface 41A in the left-right direction than the sixth outer surface 42B is to the first outer surface 41A in the left-right direction.

Specifically, the fifth outer surface 42A is continuous with the first outer surface 41A in the up-down direction without any steps or irregularities. In other words, when viewed in the up-down direction, a portion of the fifth outer surface 42A overlaps the first outer surface 41A so as to be flush with the first outer surface 41A.

The sixth outer surface 42B is arranged further rightward relative to the second outer surface 41B. In other words, the second case 42 extends to the right of the second outer surface 41B. The distance between the first outer surface 41A and the fifth outer surface 42A in the left-right direction is shorter than the distance between the second outer surface 41B and the sixth outer surface 42B in the left-right direction.

The seventh outer surface 42C is the rear outermost surface of the second case 42. The eighth outer surface 42D is the front outermost surface of the second case 42. The seventh outer surface 42C is arranged closer to the third outer surface 41C in the front-rear direction than the eighth outer surface 42D is to the third outer surface 41C in the front-rear direction.

Specifically, the seventh outer surface 42C is continuous with the third outer surface 41C in the up-down direction without any steps or irregularities. In other words, when viewed in the up-down direction, a portion of the seventh outer surface 42C overlaps the third outer surface 41C so as to be flush with the third outer surface 41C.

The eighth outer surface 42D is arranged further frontward relative to the fourth outer surface 41D. In other words, the second case 42 extends to the front of the fourth outer surface 41D. The distance between the third outer surface 41C and the seventh outer surface 42C in the front-rear direction is shorter than the distance between the fourth outer surface 41D and the eighth outer surface 42D in the front-rear direction.

The volume of the second case 42 is larger than the volume of the first case 41. The center of gravity G of a printing tape accommodation part, which is a combination of the second case 42 and components accommodated in the second case 42 (i.e., the printing tape roll 11, first supply spool 12, etc.), overlaps the first case 41 in the up-down direction.

At least a portion of the first supply spool 12 overlaps the head opening 32B in the up-down direction. The rotational center of the first supply spool 12 (i.e., the central axis L1 of the printing tape roll 11) overlaps an inner wall 32H in the up-down direction. The inner wall 32H is a wall defining the head opening 32B when viewed in the up-down direction. The inner surface of the inner wall 32H crosses a virtual plane orthogonal to the up-down direction (e.g., the bottom surface of the partitioning wall 33C), the inner surface defining the head opening 32B.

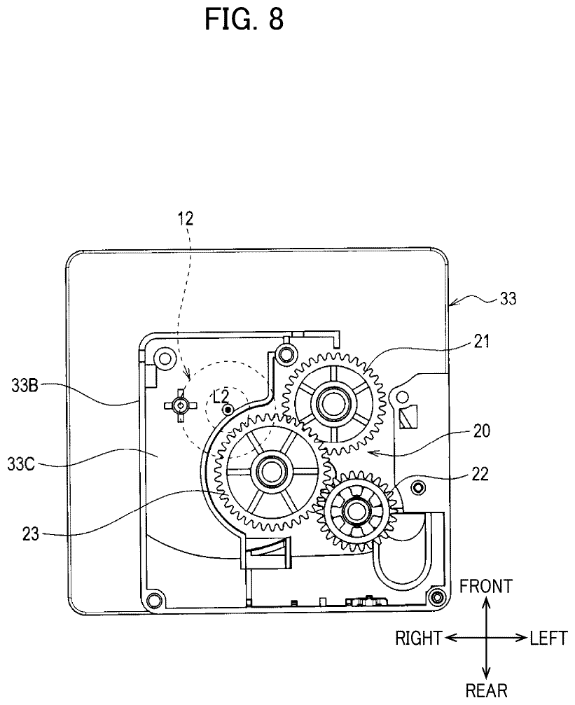

As shown in FIG. 8, the first supply spool 12 overlaps the partitioning wall 33C in the up-down direction. Further, a rotational axis L2 of the first supply spool 12 does not overlap the drive transmission mechanism 20 in the up-down direction. In other words, the rotational axis L2 of the first supply spool 12 does not overlap the output gear 21, the input gear 22 or idle gear 23 in the up-down direction.

<Conveyance and Printing of Tape with the Printing Device Body>

In a state where the printing cassette 10 is attached to the printing device body 100, the print head 102 is arranged in the head opening 32B at a position overlapping the printing tape 11A and ink ribbon 14A in the front-rear direction.

The printing tape 11A is conveyed to the head opening 32B by the platen roller 103 and is pressed, through the ink ribbon 14A, against the print head 102 whose heating elements have been heated. As a result, some of the ink provided on the surface of the ink ribbon 14A is transferred onto the printing tape 11A to print characters, symbols, and the like on the printing tape 11A.

The platen roller 103 conveys the printed printing tape 11A from the inside of the printing cassette 10 toward the outside through the discharge opening 32C. The platen roller 103 is rotated by the platen gear engaged with the output gear 21. The platen roller 103 is pivotable by the roller holder 104 between a position away from the printing cassette 10 and a position for engaging the platen gear with the output gear 21.

In a state where the main case 35 of the printing cassette 10 is inserted in the cassette accommodation part 101, the drive shaft 105 is engaged with the input gear 22 and the platen gear is engaged with the output gear 21.

Specifically, the platen gear comes into engagement with the output gear 21 by the platen roller 103 pivoting toward the head opening 32B of the printing cassette 10 in a state where the drive shaft 105 is inserted in the take-up spool 16 and input gear 22 of the printing cassette 10.

In a state where the printing cassette 10 is attached, the drive shaft 105 rotates the input gear 22, which causes the output gear 21 to rotate. The rotation of the output gear 21 rotates the platen gear, and hence, the platen roller 103 also rotates.

### 1-2. Effects

The embodiment described above can obtain the following effects.
(1a) Since the printing tape roll 11 and the first case 41 are arranged at different positions in the axial direction of the printing tape roll 11, the diameter of the printing tape roll 11 can be increased while preserving the size of the first case 41, which is to be inserted in the printing device body 100. As a result, the capacity of the printing tape 11A can be increased while reducing restrictions caused by the shape of the cassette accommodation part 101 formed in the printing device body 100.
(1b) Since the second case 42 has the outer surfaces that are continuous with the first outer surface 41A and the third outer surface 41C in the up-down direction, productivity of the printing cassette 10 can be improved while increasing the volume of the second case 42.
(1c) Since the center of gravity of the printing tape accommodation part, which includes the second case 42, overlaps the first case 41 in the up-down direction, the printing cassette 10 can be suppressed from tipping over when the printing cassette 10 is placed on a surface in an orientation where the second case 42 is on top.
(1d) Since the first pawl 32F overlaps the printing tape roll 11 in the up-down direction, the size of the printing cassette 10 can be reduced in the left-right direction.
(1e) Since the detection target part 32E is provided at the fourth outer surface 41D, the detection target part 32E can be protected by the second case 42.
(1f) Since the first supply spool 12 overlaps the inner wall 32H in the up-down direction, the strength of parts that rotatably support the first supply spool 12 can be increased.
(1g) Since the first supply spool 12 overlaps the head opening 32B in the up-down direction, the size of the printing cassette 10 in the left-right and front-rear directions can be reduced.

### 2. Other Embodiments

While the embodiment of the present disclosure is described above, it should be apparent that the present disclosure can take various forms and is not limited to the above embodiment.
(2a) The printing device in the embodiment described above is not limited to a device that prints with an ink ribbon. For example, the printing device may print on a strip-shaped thermal paper. In other words, the printing cassette need not necessarily include an ink ribbon.

Stencil tape, in which a printing pattern is perforated by a thermal head, may be used as the printing tape in the printing device. When using stencil tape as the printing tape, a laminating tape for protecting the stencil tape is used as the auxiliary tape in place of the ink ribbon.
(2b) In the printing cassette of the above embodiment, the second case need not necessarily have an outer surface that is continuous with an outer surface of the first case in the up-down direction. For example, all of the fifth, sixth, seventh, and eighth outer surfaces of the second case may be arranged outside the first case when viewed in the up-down direction.
(2c) In the printing cassette of the above embodiment, the printing tape roll need not overlap the surface around the opening of the cassette accommodation part in the up-down direction in a state where the first case is inserted in the cassette accommodation part. In other words, the printing tape roll may be accommodated in the cassette accommodation part together with the second case.
(2d) In the printing cassette of the above embodiment, the drive transmission mechanism may be arranged further downward relative to the conveying passage for the printing tape. Further, the printing cassette need not necessarily include a drive transmission mechanism.
(2e) Functions possessed by a single component in the embodiment described above may be distributed among a plurality of components, and functions possessed by a plurality of components may be integrated into a single component. Additionally, some of the configurations in the embodiment described above may be omitted. Further, at least some of the configurations in the embodiment may be added to or used in place of configurations in other embodiments. All aspects included in the technical concepts identified from the recitations in the claims are embodiments of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing cassette comprising:
a printing tape roll including a printing tape; and
a first case arranged at a different position from the printing tape roll in a first direction parallel to a central axis of the printing tape roll, the first case having:
a discharge opening allowing the printing tape to be discharged outside;
a conveying passage through which the printing tape drawn off the printing tape roll is conveyed toward the discharging opening;
a first outer surface and a second outer surface, the first outer surface and the second outer surface constituting outermost surfaces of the first case in a second direction parallel to a discharging direction in which the printing tape is discharged at the discharging opening; and
a third outer surface and a fourth outer surface, the third outer surface and the fourth outer surface constituting outermost surfaces of the first case in a third direction orthogonal to both the first direction and the second direction,
wherein the printing tape roll has an overlapping portion overlapping the first case in the first direction, and
wherein at least one of the first outer surface, the second outer surface, the third outer surface, or the fourth outer surface is spaced apart from the central axis of the printing tape roll by a distance that is shorter than an outer radius of the printing tape roll.

2. The printing cassette according to claim 1, further comprising:
a second case accommodating therein the printing tape roll.

3. The printing cassette according to claim 2,
wherein the second case has a fifth outer surface and a sixth outer surface, the printing tape roll being interposed between the fifth outer surface and the sixth outer surface in the second direction,
wherein the discharge opening allows the printing tape to be discharged from an inside of the first outer surface toward an outside of the first outer surface when viewed in the first direction,
wherein the fifth outer surface is arranged closer to the first outer surface in the second direction than the sixth outer surface is to the first outer surface in the second direction, and
wherein a distance between the first outer surface and the fifth outer surface in the second direction is shorter than a distance between the second outer surface and the sixth outer surface in the second direction.

4. The printing cassette according to claim 2,
wherein the first case has a head opening in which the printing tape is exposed,
wherein the second case has a seventh outer surface and an eighth outer surface, the printing tape roll being interposed between the seventh outer surface and the eighth outer surface in the third direction,
wherein the third outer surface is arranged farther from the head opening in the third direction than the fourth outer surface is from the head opening in the third direction,
wherein the seventh outer surface is arranged closer to the third outer surface in the third direction than the eighth outer surface is to the third outer surface in the third direction, and
wherein a distance between the third outer surface and the seventh outer surface in the third direction is shorter than a distance between the fourth outer surface and the eighth outer surface in the third direction.

5. The printing cassette according to claim 2,
wherein the second case has an outer surface continuous with at least one of the first outer surface, the second outer surface, the third outer surface or the fourth outer surface in the first direction.

6. The printing cassette according to claim 2,
wherein a volume of the second case is larger than a volume of the first case.

7. The printing cassette according to claim 2,
wherein a center of gravity of a printing tape accommodation part overlaps the first case in the first direction, the printing tape accommodation part being a combination of the second case and components accommodated in the second case.

8. The printing cassette according to claim 1,
wherein the first case includes a pawl configured to engage with a printing device body into which the first case is inserted, and
wherein the pawl is provided on one of the first outer surface, the second outer surface, the third outer surface, and the fourth outer surface, the one being spaced apart from the central axis of the printing tape roll by a distance that is shorter than the outer radius of the printing tape roll.

9. The printing cassette according to claim 8,
wherein the pawl overlaps the printing tape roll in the first direction.

10. The printing cassette according to claim 1,
wherein the first case includes a detection target part, the detection target part enabling a printing device body to detect cassette identification information, the first case being inserted into the printing device body, and
wherein the detection target part is provided at one of the first outer surface, the second outer surface, the third outer surface, and the fourth outer surface, the one being spaced apart from the central axis of the printing tape roll by a distance that is shorter than the outer radius of the printing tape roll.

11. The printing cassette according to claim 1,
wherein one of the first outer surface, the second outer surface, the third outer surface, and the fourth outer surface, faces a roller holder of a printing device body in a state where the first case is inserted in the printing device body, the one being spaced apart from the central axis of the printing tape roll by a distance that is shorter than the outer radius of the printing tape roll, the roller holder holding a platen roller of the printing device body.

12. The printing cassette according to claim 1,
wherein the overlapping portion does not include a draw-off portion of the printing tape roll at which the printing tape is drawn off the printing tape roll.

13. The printing cassette according to claim 1,
wherein a portion of an outer circumferential surface of the printing tape roll that is included in the overlapping portion has a length less than half a total circumferential length of the printing tape roll.

14. The printing cassette according to claim 1, further comprising:
a spool about which the printing tape is wound,
wherein the first case has a head opening in which the printing tape is exposed, and
wherein at least a portion of the spool overlaps the head opening in the first direction.

15. The printing cassette according to claim 1, further comprising:
a spool about which the printing tape is wound,
wherein the first case has:
a head opening in which the printing tape is exposed; and
an inner wall defining the head opening when viewed in the first direction, and
wherein a rotational axis of the spool overlaps the inner wall in the first direction.

16. The printing cassette according to claim 1, further comprising:
a spool about which the printing tape is wound; and
at least one gear configured to transmit a driving force,
wherein a rotational axis of the spool does not overlap the at least one gear in the first direction.

17. The printing cassette according to claim 1,
wherein, in a state where the first case is inserted in a cassette accommodation part, the printing tape roll overlaps a surface around an opening of the cassette accommodation part in the first direction.
